(19) United States
(12) Patent Application Publication
(10) Pub. No.: US 2004/0080603 A1
(43) Pub. Date: Apr. 29, 2004

(54) Thermal Printer

(76) Inventors: Akihiko Ito, Chiba-shi (JP); Seiichi Jimbo, Chiba-shi (JP); Takumi Seino, Chiba-shi (JP)

Correspondence Address: ADAMS & WILKS, 31st Floor, 50 Broadway, New York, NY, 10004, US

(21) Appl. No.: 10/659,503

(22) Filed: Sep. 10, 2003

(30) Foreign Application Priority Data
Sep. 25, 2002 (JP) 2002-279011

(51) Int. Cl. B41J 2/32

(52) U.S. Cl. 347/197

(57) ABSTRACT

A thermal printer is provided in which the occurrence of a sticking phenomenon can be lowered compared with a thermal printer with a conventional structure under conditions where other causes are the same therewith, which are involved in the occurrence of the sticking phenomenon, such as a period of time from drive of a heating element until the next rotation of a platen roller and respective coefficients of friction of recording paper, a thermal head, and the platen roller. In a thermal printer in which printing and paper feeding are performed in a state in which paper is sandwiched between a thermal head having a heating element and a platen roller pressed against the thermal head, a center of a rotating support shaft 7 that rotatably supports the thermal head 3 is arranged so as to be overlapped on an extension line of a head surface 3a, and also, an acting force of a spring 4 that generates a pressing force between the thermal head 3 and the platen roller 2 is made perpendicular to the head surface 3a.

### FIELD OF THE INVENTION

The present invention relates to a thermal printer in which printing is performed while paper is sandwiched between a thermal head and a platen roller, and relates to a technique usefully utilized in the so-called label printer in which printing is performed on, for example, a recording sheet with a sheet of release paper a back-side adhesion surface of which is exposed by releasing the sheet of release paper.

### DESCRIPTION OF THE RELATED ART

Thermal printers, in which printing is performed by pressing thermal recording paper between a thermal head having a heating element and a platen roller, are often applied to, for example, a printer for performing receipt-printing in a cash register and a portable printer for performing printing of POS labels for foods and labels for distribution management (for example, refer to Patent Document 1).

There has been printing failure called sticking as defects that may happen in the above-described thermal printers. Sticking is a phenomenon in which recording paper is temporarily adhered to a thermal head in printing. The phenomenon causes defects that: printing characters are crushed because of recording paper not advancing even if a platen roller is rotated; and restoration work has to be performed so as to release recording paper from a thermal head and other defects.

The above-described sticking phenomenon has been likely to occur particularly in, for example, the case of using a thermal printer of type in which a period of time from drive of heating elements of a thermal head until the next rotation of a platen roller is long (for example, type in which heating elements are divided into plural blocks to be driven in block units because of the length of a printing width and for the reasons in terms of power) and the case of using recording paper whose back surface has a small frictional resistance (for example, a recording sheet with a sheet of release paper whose back-side adhesion surface is exposed by releasing the sheet of release paper). That is, it has been necessary that attention is paid on in order that the sticking phenomenon does not occur in a label printer with a relatively wide printing width.

[Patent Document 1]

JP 04-140175 A

The present inventors assumed that the above-described sticking phenomenon was pertinent to, as occurrence factors, various acting forces that are generated in a pressing portion between a thermal head and a platen roller, and conducted various experiments. As a result, it was confirmed that a movable direction of the thermal head, an action direction of a spring force that causes a pressing force between the thermal head and the platen roller, and the like were concerned in the occurrence factors of the sticking phenomenon, which led to the present invention.

The conventional thermal printer, as shown in FIG. 2 of Patent Document 1, generally has a structure in which: a support body (5: reference numeral in Patent Document 1) of a thermal head is rotatable about a rotating shaft (7); and the support body (5) is pushed toward the side of a platen roller (4) by a spring (13) to make the platen roller and the thermal head pressed against each other. As shown in the same figure, as to the conventional thermal printer, in most cases, the rotating shaft (7) of the head support body (5) is fixed at a position shifted to one side from a head surface, whereby a movable direction of the thermal head is slightly inclined with respect to a perpendicular direction to the head surface. Further, a direction of an acting force of the spring (13) that generates a pressing force is made oblique to the perpendicular direction to the head surface of the thermal head in many cases.

### SUMMARY OF THE INVENTION

The present invention has been made in view of the above, and therefore has an object to provide a thermal printer capable of suppressing the occurrence of sticking under conditions that other factors, which are involved in the occurrence of a sticking phenomenon, such as a period of time from drive of a heating element until the next rotation of a platen roller and respective coefficients of friction of recording paper, a thermal head, and the platen roller, are the same compared with a conventional one.

In order to achieve the above-mentioned object, according to the present invention, there is provided a thermal printer with a structure in which printing is performed through drive of a heating element, and paper feeding is performed through rotation of a platen roller in a state in which paper is sandwiched between a thermal head having the heating element and the platen roller pressed against the thermal head, in which the thermal printer includes: a movable mechanism that supports the thermal head or the platen roller in a state of being movable in a predetermined direction; and biasing means that generates a pressing force between the thermal head and the platen roller, and the predetermined direction in which the thermal head and the platen roller are made movable in a state of being pressed against each other by the movable mechanism and a biasing direction of the biasing means are perpendicular with respect to a paper feeding direction in a pressing portion between the thermal head and the platen roller.

With the above-described means, the occurrence of the sticking phenomenon, in which the paper sticks to the thermal head, may be suppressed compared with the case where the movable direction and the biasing direction are inclined with respect to the perpendicular direction. Such a conclusion is obtained mainly from the experiments which are performed while variously changing the movable direction and the biasing direction. The following reason for the conclusion is given.

That is, explanation is made with reference to a schematic diagram of FIG. 3 as an example. A complicated force is acted on a pressing portion W between a thermal head 3 and a platen roller 2 due to slight distortion of the platen roller 2, a force applied in a rotational direction, minute displacement of both the members which is caused when a rotational force is acted on the platen roller 2, and the like. In the case where a movable direction (rotational direction with a rotating support shaft 7 as a center) of the thermal head 3 is inclined (for example, an angle è1) with respect to an X direction perpendicular to a head surface 3a, it is considered that an acting force F1 in an oblique direction is exerted on paper P from the thermal head 3 along with the minute displacement of the platen roller 2 and the thermal head 3 which is caused when the rotational force is acted on the platen roller 2. Then, it is considered that a component F3 opposite to a Y direction, in which the paper P is conveyed, of the acting force F1 acts on the paper P so that the paper P remains on the side of the thermal head 3 while opposing friction of the platen roller 2. Therefore, with the above-described means according to the present invention, the component F3 of the force can be reduced to thereby suppress the occurrence of the sticking phenomenon.

Further, when a direction of a pressurizing force F5 is inclined (for example, an angle è2), the pressurizing force F5 has to be increased in order to generate a predetermined pressing force between the thermal head 3 and the platen roller 2. As a result, it is considered that a force, which is exerted from the pressurizing force F5 when the thermal head 3 moves slightly, is also increased, which acts on the paper P so that it remains on the side of the thermal head 3. With the above-described means according to the present invention, the force can be made minimum to thereby suppress the occurrence of the sticking phenomenon.

Here, in the thermal printer, the movable mechanism is a rotating mechanism that rotatably supports the thermal head about a rotating support shaft; and the rotating support shaft is arranged on a straight line along the paper feeding direction in the pressing portion. Further, in the thermal printer, the biasing means is a spring that presses the thermal head from a back side thereof; and a pressing direction of the spring is perpendicular to the paper feeding direction in the pressing portion.

Moreover, it is preferable that a center of an acting point of the spring is positioned on a plane which passes through the pressing portion between the thermal head and the platen roller and which is perpendicular to a paper feeding direction in the pressing portion. With the above structure, a spring force is directly transmitted to the pressing portion between the thermal head and the platen roller. Therefore, the complicated force, which is quite capable of becoming the occurrence factor of the sticking phenomenon and is difficult to be predicted, can be suppressed to a minimum.

### BRIEF DESCRIPTION OF THE DRAWINGS

For a more better understanding of the present invention, reference is made of a detailed description to be read in conjunction with the accompanying drawings, in which:

FIG. 1 is a side view showing a printing mechanism of a label printer to which the present invention is suitably applied;

FIG. 2 is a perspective view of the printing mechanism in FIG. 1; and

FIG. 3 is a schematic diagram respectively showing an arrangement of a rotating support shaft of a thermal head support body, a pressurizing force, and an acting force of a pressing portion.

### DETAILED DESCRIPTION OF THE PREFERED EMBODIMENT

Hereinafter, an embodiment of the present invention will be described based on the accompanying drawings.

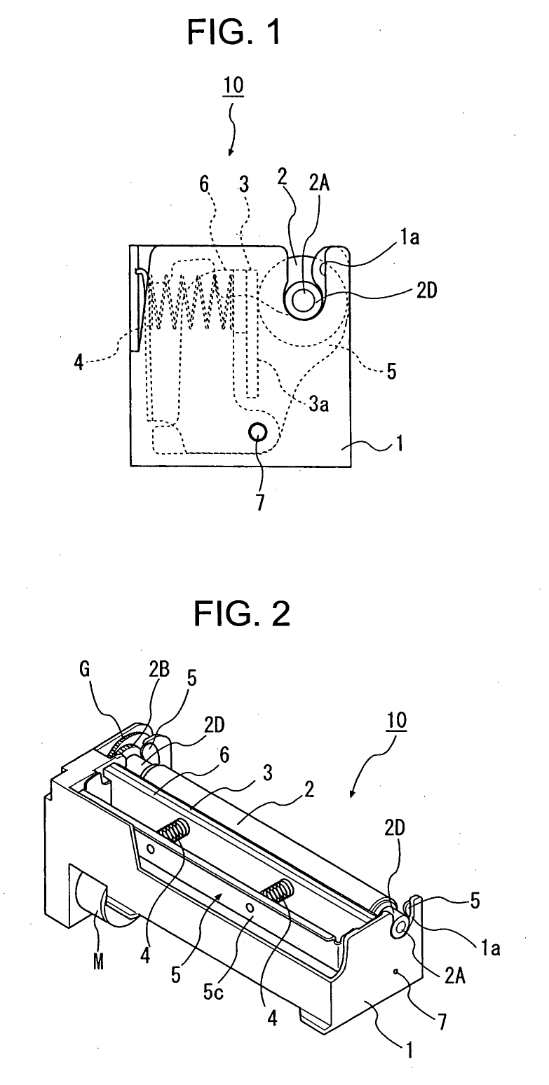

FIG. 1 is a side view showing a printing mechanism of a thermal printer to which the present invention is suitably applied, and FIG. 2 is a perspective view of the printing mechanism.

There is no particular limitation placed on the thermal printer in this embodiment. However, the thermal printer is a portable label printer in which printing is performed on, as paper, a recording sheet with a sheet of release paper (called label paper) whose back-side adhesion surface is exposed by releasing the sheet of release paper, and is of type in which printing can be performed for a relatively wide width.

As shown in FIGS. 1 and 2, the printing mechanism 10 mounted on the thermal printer is provided with: an outer frame 1 that surrounds the printing mechanism 10 in all directions; a thermal head 3 in which plural heating elements are arranged in a horizontal line; a platen roller 2 which presses paper against portions where the heating elements of the thermal head 3 are formed and which performs paper feeding through its rotation; a lock arm 5 that sandwiches and retains a bearing 2D, which rotatably supports the platen roller 2, with a U-groove 1a of the outer frame 1; a stepping motor M that rotationally drives the platen roller 2 through gears 2B and G and the like; a head support body 6 that supports the thermal head 3 and exerts a heat radiation action; a rotating support shaft 7 that rotatably supports the head support body 6 and the lock arm 5; coil springs 4, 4 as biasing means that are provided between the head support body 6 and a rear frame 5c of the lock arm 5 to bias and make them separate from each other; and the like. Among the above members, the head support body 6, the rotating support shaft 7, and a bearing hole for the rotating support shaft 7 which is provided in the outer frame 1 constitute a movable mechanism or rotating mechanism that makes the thermal head 3 movable.

The head support body 6 has a shape in which a portion of the bearing hole through which the support shaft 7 is passed is projected to a position under the thermal head 3. Thus, such an arrangement is provided in which a center of the support shaft 7 is overlapped on an extension line of a head surface 3a (surface on which the heating elements are provided) of the thermal head 3.

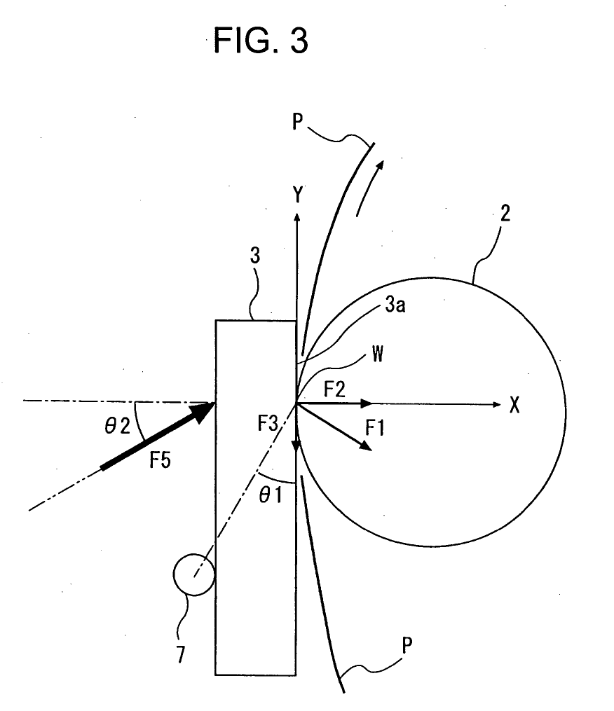

Further, the springs 4, 4 are arranged so as to push the head support body 6 in a direction perpendicular to the head surface 3a of the thermal head 3. Further, it is arranged such that centers of the acting points of the springs 4, 4 with respect to the head support body 6 are overlapped on a straight line X (FIG. 3) that extends from a pressing portion between the platen roller 2 and the thermal head 3 in the perpendicular direction to the head surface 3a.

Next, description will be made of a force acted on the pressing portion between the platen roller 2 and the thermal head 3 in the printing mechanism 10 with the above-described structure with reference to a schematic diagram of FIG. 3.

FIG. 3 is a schematic diagram respectively showing an arrangement of the rotating support shaft of the head support body, the pressurizing force of the springs, and the acting force in the pressing portion.

In the case of the printing mechanism 10 in this embodiment, an angle è1 in FIG. 3 is 0° because the rotating support shaft 7 is arranged on the extension line of the head surface 3a of the thermal head 3. Further, since the pressurizing force F5 of the springs 4 is also perpendicular to the head surface 3a, an angle è2 in FIG. 3 is 0°.

First, an action of 'è1=0° is explained. In the case where a straight line that connects the center of the rotating support shaft 7 with the pressing portion W overlaps the head surface 3a, a movable direction of the thermal head 3 is substantially exclusively an X direction in a state in which the thermal head 3 and the platen roller 2 are pressed against each other. When a driving force of the stepping motor M exerts a rotational force on the platen roller 2, in a stage in which paper P is at a standstill, a force in a Y direction is applied on the back side of the paper P from the platen roller 2 due to a frictional force; at the same time, the opposite stress is generated on the front side of the paper P from the thermal head 3.

Further, the platen roller 2 has elasticity and is pressed against the thermal head 3 in the state of slightly being distorted. Thus, the platen roller 2 is imparted with the rotational force, whereby a pressing force between the platen roller 2 and the thermal head 3 changes to slightly move the thermal head 3. Here, the direction in which the thermal head 3 moves is only the X direction perpendicular to the head surface 3a, and a component in the Y direction in which paper is fed hardly exists. Therefore, the force exerted on the paper from the thermal head 3 due to the slight movement is only a component F2 (=F1) in the X direction perpendicular to the head surface 3a, and the component F3 in the Y direction in which paper is fed hardly exists.

Moreover, a pressing force F1 (=F2) caused by the pressurizing force F5 of the springs 4 is rarely dispersed in the Y direction when the thermal head 3 moves slightly. Thus, the pressing force between the thermal head 3 and the platen roller 2 is stabilized.

The above-described actions stabilize the forces in the Y direction which are acted on the front surface and back surface of the paper when the platen roller 2 is rotated. As a result, the occurrence factors of a sticking phenomenon are significantly reduced.

Next, an action of è2=0° is explained. In the case where a predetermined pressing force needs to be generated between the thermal head 3 and the platen roller 2, the ratio of the X-directional component corresponding to the pressing force is lowered as the angle è2 of the pressurizing force F5 is made oblique, for example, 30° and 60°, and thus, the pressurizing force F5 itself has to be increased. Therefore, when the angle è2 is set at 0°, the pressurizing force F5 necessary for obtaining the predetermined pressing force is at the minimum.

Even in the case where the rotating support shaft 7 of the thermal head 3 is located on the extension line of the head surface, the thermal head 3 can be slightly displaced in the Y direction due to a clearance of the bearing hole that bears the rotating support shaft 7, assembly back-lash, and the like. Then, the force F3 in the Y direction may be slightly exerted on the paper from the thermal head 3 along with the displacement. In this case, when the pressurizing force F5 is increased, the force F3 is increased accordingly. Therefore, when the force F3 is made at the minimum with the angle è2 being 0°, the forces in the Y direction, which are exerted on the front surface and back surface of the paper when the platen roller 2 is rotated, are stabilized. As a result, the occurrence factors of the sticking phenomenon are reduced.

In addition, an acting point of the pressurizing force F5 is located on the straight line that is extended in the X direction from the pressing portion W, whereby the pressurizing force F5 is directly transmitted to the pressing portion W, and the stress with respect to the pressurizing force F5, which is generated on the other portions, for example, the rotating support shaft 7, is decreased. Thus, there is less generated a complicated force which is quite capable of becoming an occurrence factor of the sticking phenomenon and which is difficult to be predicted. Therefore, a stable pressing force is obtained, and the force in the Y direction, which is caused when the platen roller 2 is rotated, is stabilized.

As described above, according to the label printer in this embodiment, the occurrence factors of the sticking phenomenon are reduced. Thus, the occurrence rate of sticking can be significantly suppressed even if the label printer uses label paper whose back surface has a relatively small coefficient of friction and is of type capable of performing printing for a relatively wide width.

Note that the present invention is not limited to the above embodiment, and various changes can be made. For example, the directions of the respective forces are defined relative to the head surface 3a on which the heating elements are provided in the explanation since the thermal head 3 has a flat plate-shape in the embodiment. However, in the case where the surface, on which the heating elements are provided, of the thermal head is not a plane, the directions of the respective forces are similarly defined relative to a surface in the pressing portion between the thermal head and the platen roller (or paper feeding direction). As a result, the actions similar to those in the embodiment can be obtained.

Further, in the embodiment, the description is made of the example in which the present invention is applied to the structure in which: the arrangement of the platen roller 2 is fixed; and the thermal head 3 is rotatably supported about the support shaft 7. On the contrary, the present invention can be also applied to a structure in which: the thermal head 3 is fixed; and the platen roller 2 is rotatable and is supported in the state of being movable in a predetermined direction. In this case, a structure may be adopted in which the direction in which the platen roller 2 is movable and the biasing direction of the spring or the like that exerts the biasing force to the platen roller to generate the pressing force are perpendicular to the head surface of the pressing portion.

Moreover, in the above embodiment, the example is shown in which the present invention is applied to the portable label printer. However, the present invention can be widely applied to various thermal printers with a printing mechanism in which printing and paper feeding are performed while paper is clamped between a thermal head having heating elements and a platen roller.

As described above, according to the present invention, the thermal printer provides an effect in which the occurrence rate of the sticking phenomenon can be remarkably lowered compared with a conventional one under the conditions where other causes are the same therewith, which are involved in the occurrence of the sticking phenomenon, such as the respective coefficients of friction of the paper, the thermal head, and the platen roller and the period of time from drive of the heating elements until the next rotation of the platen roller.

What is claimed is:

1. A thermal printer with a structure in which: printing is performed through drive of a heating element, and paper feeding is performed through rotation of a platen roller in a state in which paper is sandwiched between a thermal head having the heating element and the platen roller pressed against the thermal head, comprising:
a movable mechanism supporting the thermal head or the platen roller in a state of being movable in a predetermined direction; and
biasing means generating a pressing force between the thermal head and the platen roller;
wherein the predetermined direction in which the thermal head and the platen roller are made movable in a state of being pressed against each other by the movable mechanism and a biasing direction of the biasing means are perpendicular with respect to a paper feeding direction in a pressing portion between the thermal head and the platen roller.

2. A thermal printer according to claim 1, wherein the movable mechanism is a rotating mechanism that rotatably supports the thermal head about a rotating support shaft, and the rotating support shaft is arranged on a straight line along the paper feeding direction in the pressing portion.

3. A thermal printer according to claim 1, wherein the biasing means is a spring that presses the thermal head from a back side thereof, and a pressing direction of the spring is perpendicular to the paper feeding direction in the pressing portion.

4. A thermal printer according to claim 3, wherein a center of an acting point of the spring is arranged so as to be located on a plane which passes through the pressing portion between the thermal head and the platen roller and which is perpendicular to the paper feeding direction in the pressing portion.
